(19) United States
(12) Patent Application Publication
(10) Pub. No.: US 2004/0038186 A1
(43) Pub. Date: Feb. 26, 2004

(54) Tactile feedback device

(76) Inventors: Michael Joseph Martin, Boise, ID (US); William Edward Britton, Boise, ID (US); Daniel Eugene Beltzer, Boise, ID (US)

Correspondence Address: HEWLETT-PACKARD COMPANY, Intellectual Property Administration, P.O. Box 27240, Fort Collins, CO, 80527-2400, US

(21) Appl. No.: 10/224,602

(22) Filed: Aug. 21, 2002

(51) Int. Cl. G09B 21/00

(52) U.S. Cl. 434/113; 434/112; 434/114

(57) ABSTRACT

A tactile feedback device includes a plurality of tactile elements. At least one of the plurality of tactile elements includes a movable member and an expandable substance positioned adjacent to the movable member. The movable member is displaced to provide tactile feedback in response to the expandable substance being expanded.

### FIELD OF THE INVENTION

The present invention relates generally to tactile feedback devices, and more particularly to a tactile feedback device including movable members which may be displaced to provide tactile feedback.

### BACKGROUND OF THE INVENTION

Most of the information conveyed to a user of a computer device (e.g., personal computer (PC), personal digital assistant (PDA), work station, telephone, calculator, automatic teller machine, and the like) utilizes a display.

These displays, however, are typically not able to convey information to handicapped users. As a result, accessibility devices that make it possible for the handicapped to interface with a computer device have been developed. These accessibility devices, however, are typically complicated, costly to manufacture, or not readily incorporated into a variety of devices.

### SUMMARY OF THE INVENTION

According to one embodiment of the invention, a tactile feedback device comprises a plurality of tactile elements. At least one of the tactile elements includes a movable member and an expandable substance positioned adjacent to the movable member. The movable member is configured to be displaced to provide tactile feedback responsive to an expansion of the expandable substance.

According to another embodiment of the invention, a refreshable Braille display is connected to a printing device. The Braille display is configured to generate Braille characters representing information related to the printing device. The Braille display comprises a plurality of tactile elements. At least one of the tactile elements includes a movable member and an expandable substance positioned adjacent to the movable member. The movable member is configured to be displaced responsive to an expansion of the expandable substance. The movable member is displaced to provide tactile feedback of a Braille bump in a Braille character.

According to yet another embodiment of the invention, a method of providing tactile feedback of characters on a refreshable display is disclosed. The display comprises a plurality of tactile elements. At least one of the tactile elements includes an expandable substance and a movable member configured to be displaced with respect to a reference surface of the display. The method comprises steps of expanding the expandable substance and displacing a tactile surface of the movable member beyond the reference surface in response to expanding the expandable substance. The displaced tactile surface provides tactile feedback.

According to yet another embodiment of the invention, a tactile feedback device comprises a substance means for expanding and a member means for providing tactile feedback. The member means is adjacent to the substance means and may be displaced to provide the tactile feedback responsive to an expansion of the substance means.

### BRIEF DESCRIPTION OF THE DRAWINGS

The present invention is illustrated by way of example and not limitation in the accompanying figures in which like numeral references refer to like elements, and wherein:

FIG. 1 illustrates a refreshable display, according to an embodiment of the invention;

FIG. 2 illustrates a side view of a tactile element in a non-raised position, according to an embodiment of the invention;

FIG. 3 illustrates a side view of a tactile element in a raised position, according to an embodiment of the invention;

FIG. 4 illustrates a block diagram of the display of FIG. 1 connected to a printing device, according to an embodiment of the invention;

FIG. 5 illustrates a laser printer with the display of FIG. 1, according to an embodiment of the invention; and

FIG. 6 is a flowchart of an exemplary method, according to an embodiment of the invention.

### DETAILED DESCRIPTION OF A PREFERRED EMBODIMENT

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

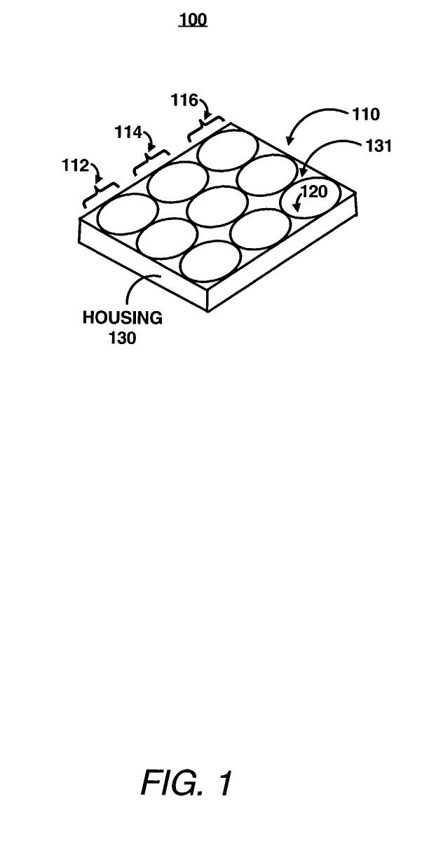

FIG. 1 illustrates a refreshable display 100 according to an embodiment of the invention. The display 100 includes multiple tactile elements 110 that provide tactile feedback. A tactile element 120 is specifically labeled. The tactile elements 110 may be provided in a housing 130. The tactile elements 110 may be displaced with respect to an outer surface 131 of the housing 130 for providing tactile feedback.

In one embodiment, the tactile elements 110, for example, may provide tactile feedback of one or more Braille bumps in a Braille display. The tactile elements 110 may be arranged in an array. For example, the array may include two columns (e.g., columns 112 and 114) of three tactile elements to generate Braille characters, or three columns (e.g., columns 112, 114 and 116) of three tactile elements.

More than two columns may be used to provide a scrolling effect. For example, the user may slide a finger across multiple columns to read multiple Braille characters. A scrolling effect may also be generated by refreshing the display 100 while a user's finger remains stationary. A Braille character is composed of several rows and several columns, so the display 100 simultaneously refreshes all the columns and rows for each character when providing the scrolling effect. A user holds his or her finger in one location on the display 100, and the display 100 continually refreshes to provide tactile feedback of multiple characters. Alternatively, several characters change as the person slides his or her finger across the array, such as when more than two columns are used to generate multiple characters to provide the scrolling effect. Also, if necessary, each column may include more than three tactile elements, for example, for displaying graphics and/or special Braille or other characters.

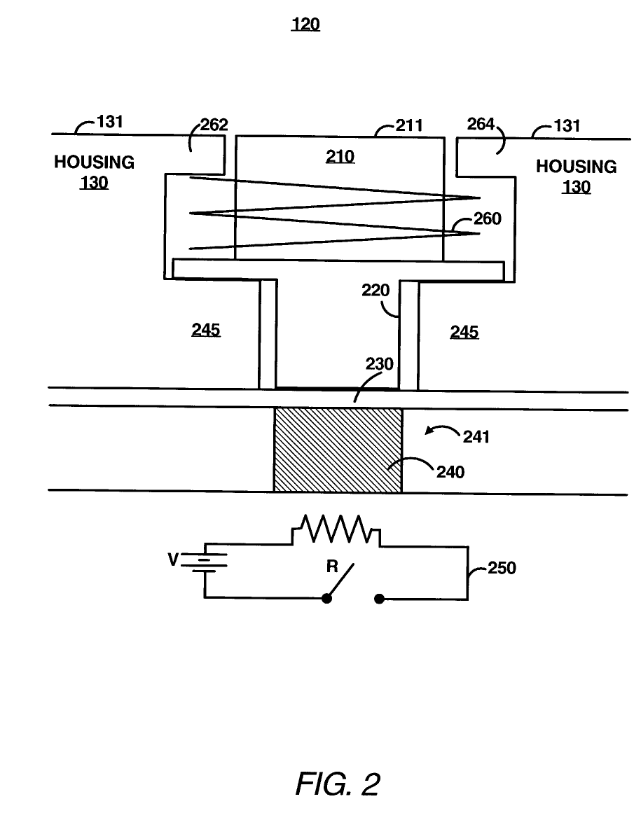

FIG. 2 illustrates a side view of a tactile element, such as the tactile element 120. The tactile element 120 includes a button 210. The button 210 may be recessed in the housing 130 or approximately level with the outer surface 131 of the housing 130. The button 210 may include a dome with rounded edges for a user's comfort. Alternatively, the button 210 may include other shapes and sizes known in the art. The button 210 also includes a tactile surface 211. The tactile surface 211 may be felt by a user to provide tactile feedback. The tactile surface 211 may comprise a smooth or rough surface to provide tactile feedback. Other surface textures known in the art may also be used.

The button 210 is supported by a pin 220. The button 210 and the pin 220 may comprise a single movable unit or may comprise separate units. The pin 220 is in contact with a flexible membrane 230, and the flexible membrane 230 is in contact with an expandable medium 240. The expandable medium 240 may be supported within the housing 130 to generally enable expansion thereof in a relatively upward direction. By way of example and as shown in FIG. 2, the expandable medium 240 may be supported on the sides and be supported from below by the housing 130, such that the housing 130 includes a recess 241 or chamber for supporting the expandable medium 240. The expandable medium 240 is sealed in the recess 241 by the flexible membrane 230.

The expandable medium 240 may be expanded, for example, by applying heat generated by a heating circuit 250 to the expandable medium 240. When the expandable medium 240 is heated by the heating circuit 250, the expandable medium 240 expands, causing the flexible membrane 230 to be displaced or stretched. Generally, the flexible membrane 230, the pin 220, and the button 210 are displaced with respect to a reference surface (e.g., the outer surface 131) in response to the expandable medium being expanded. The displacement of the flexible membrane 230, the pin 220, and the button 210 is described in detail below.

The expandable medium 240 may be sealed in the recess by the flexible membrane 230. Bottom portions 245 of a support structure may hold the flexible membrane 230 in a substantially fixed location. The bottom portions 245 may be integrally formed with the housing 130. The bottom portions 245 may be attached to the flexible membrane 230 or provide a clamping force to the flexible membrane 230 to hold the flexible membrane 230 in a substantially fixed location. This allows the expandable medium 240 to remain sealed in the recess 241 by the flexible membrane 230. When the flexible membrane 230 is stretched upward, the bottom portions 245 hold the ends of the flexible membrane 230 against the support structure, such that the expandable medium 240 remains sealed in the recess 241. The flexible membrane 230 may extend the entire length of the display 100 or may be positioned above the expandable medium for each of the tactile elements 110. Other attachment devices known in the art may be used to hold the flexible membrane 230 in a fixed location.

FIG. 2 illustrates the button 210 in a non-raised or lowered position. When in the non-raised position, the button 210, for example, may indicate an absence of information, such as a non-existent Braille bump in a Braille display.

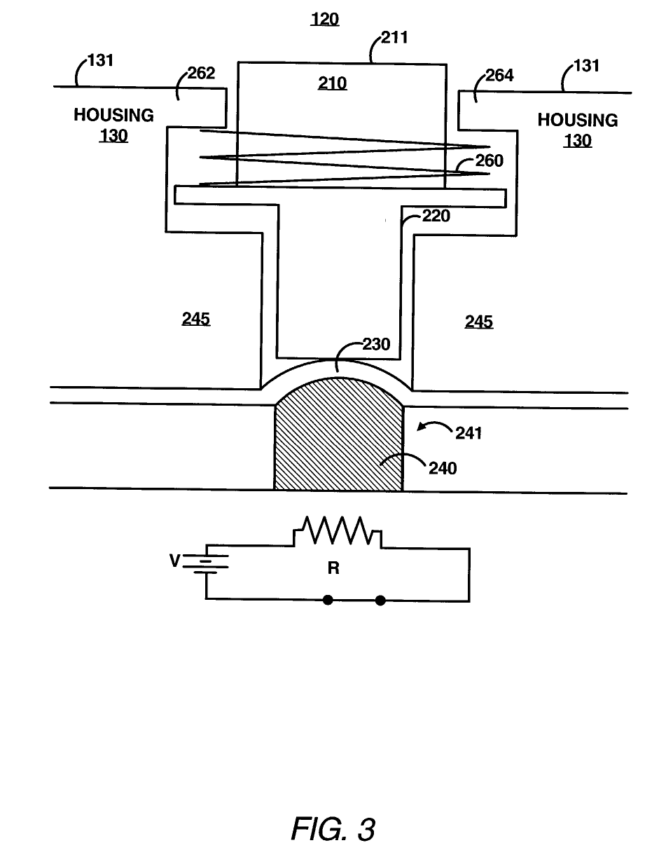

FIG. 3 illustrates a side view of the tactile element 120, in which the button 210 is in a raised position distal from the non-raised position. In the raised position, the tactile surface 211 of the button 210 protrudes beyond the outer surface 131). In the raised position, the button 210 may provide tactile feedback, for example, of a Braille bump. As seen in FIG. 3, when the expandable medium 240 is heated, e.g., by activating the heating circuit 250, the expandable medium 240 expands. This expansion may be controlled to substantially drive the flexible membrane 230 in an upward direction. As the flexible membrane 230 is pushed generally upward, the pin 220 in contact with the flexible membrane 230 is also caused to move in the upward direction. Because the button 210 is in contact with pin 220, the button 210 is further caused to move in the upward direction. The upward direction may include a direction perpendicular to an outer surface (e.g., the outer surface 131) of the housing 130. It will be apparent to one of ordinary skill in the art that the tactile element 120 may be oriented in a vertical, horizontal or other angular positions. For example, the display 100 including one or more tactile elements 120 may be angularly oriented for ergonomic reasons. Therefore, the upward direction includes the direction the button 210 is displaced when the expandable medium 240 is expanded.

The tactile element 120 may also include a spring 260 configured to apply a downward force on the button 210. As shown in FIG. 2, the spring 260 is positioned under lips 262 and 264 of the housing 130. The force of the spring 260 under the lips 262 and 264 generally holds the button 210 in the non-raised position. The spring 260 is generally uncompressed in FIG. 2, which maintains the pin 220 in a resting, non-raised position. The spring 260 may include a single spring, which may be placed around the button 210, or at least two springs, where one spring is placed under each of the lips 262 and 264.

As shown in FIG. 3, the expanded expandable medium 240 generates an upward force sufficient to compress the spring 260. This force causes the button 210 to rise to the raised position as described above. When the expandable medium 240 cools and returns to a substantially unexpanded state, such as shown in FIG. 2, the button 210 returns to the non-raised position. The expandable medium 240 may be selectively heated and then allowed to cool to allow the display 100 to refresh and continuously display one or more characters. In one embodiment, the expandable medium 240 is configured to expand when the resistor R in the heating circuit 250 is heated and to return to an unexpanded state when the expandable medium 240 is not being heated.

The expandable medium 240 may include water or other expandable substances which can be quickly expanded and returned to an unexpanded state to allow the display 100 to be continuously refreshed.

The remaining tactile elements 110 may include the same features of the tactile element 120. Also, power may be selectively applied to heating circuits for one or more of the tactile elements 120, such that the display 100 provides tactile feedback of one or more characters, which may include Braille characters. The display 100 is not limited to displaying Braille characters and may be activated to provide tactile feedback of graphics, letters, numbers, and the like. The spring 260 may be optional in the tactile elements 120.

The display 100 may be placed on a variety of accessibility devices to provide tactile feedback for the visually impaired. For example, the display 100 may be placed on computer input devices (e.g., mouse, trackball, joystick, stylus, etc.), computer devices (e.g., PDA, work station, etc.), household devices (e.g., telephone, oven, refrigerator, etc.), automatic teller machines, and the like.

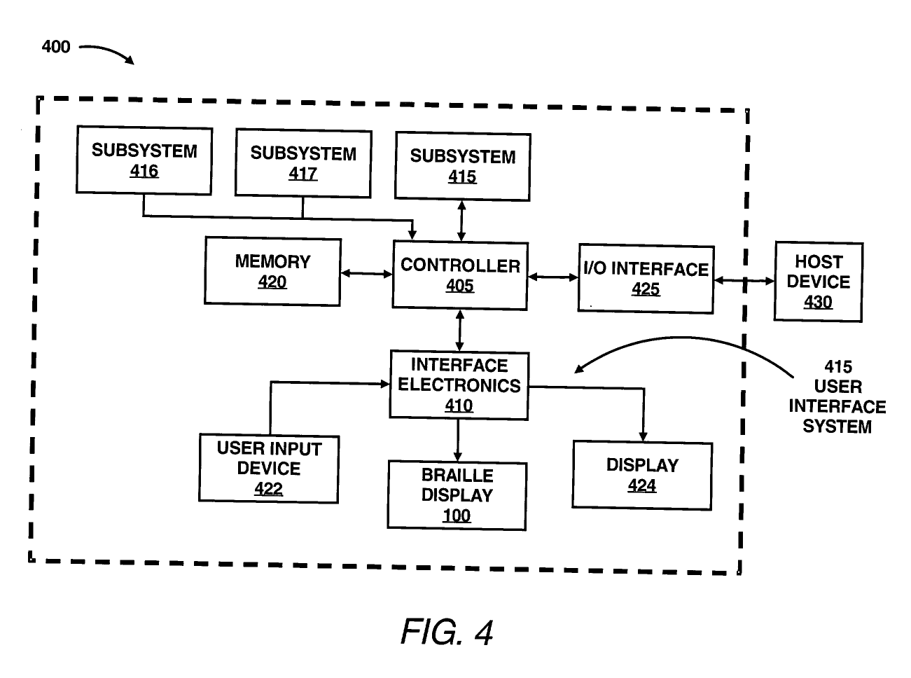

In another embodiment, the display 100 is connected to a printing device 200. FIG. 4 illustrates a block diagram of the display 100 connected to the printing device 400. The printing device 400 may include a printer, copier, facsimile, and the like.

The printing device 400 includes a controller 405 connected to multiple subsystems 415-417. The controller 405 is also connected to a memory 420 and a host device 430.

The controller 405 may be configured to provide control logic for the printing device 400 (e.g., the functionality for a printer). In this respect, the controller 405 may possess a microprocessor, a micro-controller, an application specific integrated circuit, and the like. The controller 405 may be interfaced with the memory 420 that is configured to provide storage of a computer software program that provides the functionality for the printing device 400. The memory 420 may be implemented as a combination of volatile and non-volatile memory, such as dynamic random access memory (“RAM”), EEPROM, flash memory, and the like.

The printing device 400 may be connected to the host device 430 (e.g., personal computer, server, personal digital assistant, and the like) through an I/O interface 425. The I/O interface 425 is configured to provide a communication channel between the host device 430 and the controller 405. The I/O interface 425 may conform to protocols, such as RS-232, parallel, small computer system interface, universal serial bus, etc. The printing device 400 may also include a standalone device that is not connected to a host device.

The controller 405 is connected to the user interface subsystem 415. The user interface subsystem 415 includes interface electronics 410, user interface 422, the display 100 and a display 424. The user interface 422, the display 100 and the display 424 are connected to the controller 405 through the interface electronics 410. The interface electronics 410 may include one or more circuit boards, ASIC(s), processor, etc., that facilitate communication with the controller 405 and operation of the display 100, user interface 422 and the display 424. For example, the user interface electronics 410 receive information to be output on the display 100 from the controller 405. The interface electronics 410 selectively provides power to various heating circuits for the tactile elements 110 to generate characters on the display representative of the information received from the controller 405.

The user interface 422 may include a keypad, buttons, etc., that allow a user to input information into the printing device 400. The information may include print settings, printer settings, print job information, etc. The graphical display 424 may include a conventional display on a printing device for displaying information. The display 100 is described in detail above and provides tactile feedback of information, such as information displayed on the display 424. The information may include printing device settings (e.g., printer settings, and the like), print job information including print job settings, maintenance information, etc. The user interface 422, the display 100 and the display 424 may be placed on a single control panel on the printing device 400 or be placed in different locations on the printing device 400.

The memory 420 may store software for controlling the display 100. Firmware may also be used. In one embodiment, the controller 405 transmits signals to the interface electronics 410 to generate Braille characters on the display 100. The interface electronics 410 receives the signals from the controller 405 and selectively activates the tactile elements 110 to generate Braille characters on the display 100. It will be apparent to one of ordinary skill in the art that tactile feedback of characters other than Braille characters may be provided by the display 100.

The subsystems 415-417 may include a plurality of conventional subsystems, e.g., a print module, in the printing device 400 that facilitate printing through the printing device 400.

In other embodiments, the display 100 and associated electronics may be provided as an add-on device that can be connected to a port in the printing device 100 or to an accessibility device.

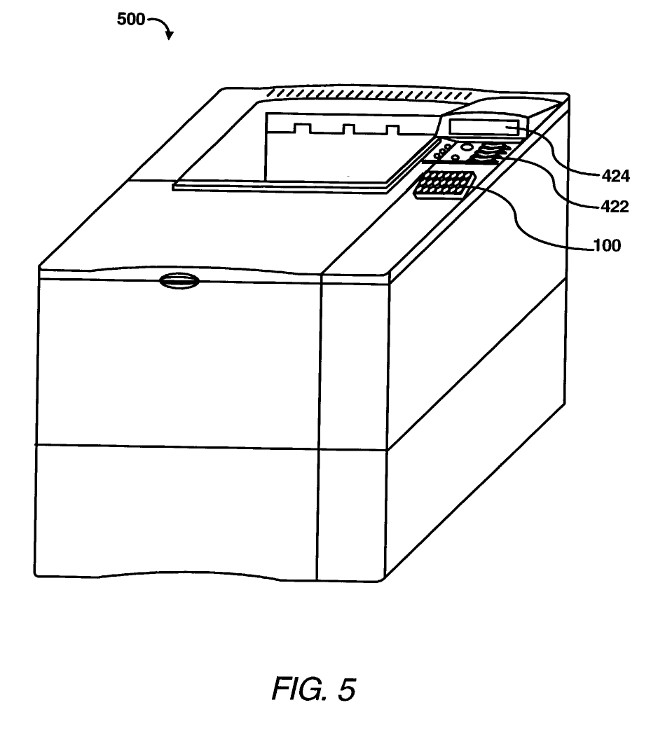

FIG. 5 illustrates an embodiment of the printing device 400 as a laser printer 500. The laser printer 500 includes the user interface 422, the display 100 and the display 424 provided on a top surface of the laser printer 500.

In FIG. 5, the display 100 is illustrated as being integrated with the printer 500. As described hereinabove, it should be understood that the display 100 may comprise a separate element connected to the printer 500. In addition, although a laser printer is illustrated in FIG. 5, it is within the purview of the present invention that certain embodiments of the invention may be implemented with various other types of printing devices, e.g., inkjet printers, photocopiers, facsimile machines, etc.

The display 100 illustrated in FIGS. 1-5 is not limited to providing tactile feedback of Braille characters and can provide feedback for any type of character. Furthermore, it will be apparent that the elements 110 of the display 100 may be used in any type of device to provide tactile feedback. In addition, the display 100 shown in FIG. 5 is illustrated as being angularly raised from a surface of the printer 500. The display 100, however, may be orientated on the printer 500 in a variety of manners, such as flush with a surface of the printer, raised from a surface of the printer, embedded slightly below a surface of the printer, etc.

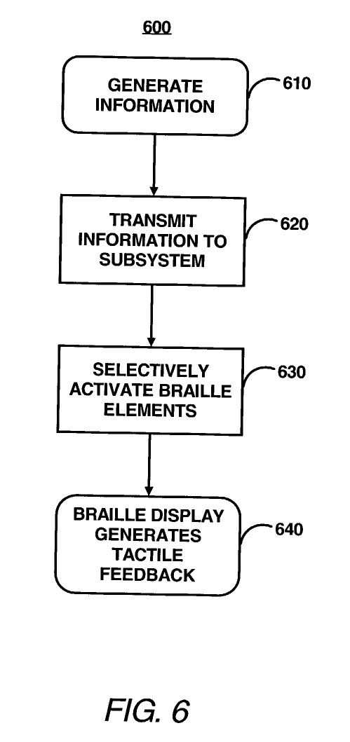

FIG. 6 illustrates a flow chart for an exemplary method 600 of providing tactile feedback of information through the display 100 connected to the printing device 500. In step 610, the controller 405 generates information to be transmitted to a user. For the printer 500, shown in FIG. 5, this information may include print settings, printer maintenance information, and other information that is generally provided through a conventional display on a printer. In step 620, the controller transmits the information to the user interface electronics 410. In step 630, the user interface electronics 410 selectively activates the tactile elements 110. For example, a voltage is selectively applied to the heating circuits of various tactile elements 110, which causes buttons for the various tactile elements 110 to rise to the raised position. In step 640, the display 100 provides tactile feedback of the information through the raised buttons on the display 100.

Certain steps of the method 600 can be performed by a computer program. The computer program can exist in a variety of forms both active and inactive. For example, the computer program and objects can exist as software comprised of program instructions or statements in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. Those skilled in the art will recognize that these and many other variations are possible within the scope of the invention, as defined by the following claims, and their equivalents, in which all terms are meant in their broadest reasonable sense unless otherwise indicated.

What is claimed is:

1. A tactile feedback device having a plurality of tactile elements, at least one of the tactile elements comprising:
a movable member; and
an expandable substance positioned adjacent the movable member, the movable member being displaced to provide tactile feedback responsive to an expansion of the expandable substance.

2. The tactile feedback device of claim 1, wherein the expandable substance is expanded in response to being heated.

3. The tactile feedback device of claim 1, wherein the at least one tactile element further comprises a flexible membrane located between the expandable substance and the movable member; wherein the expandable substance expands to displace the flexible member such that the flexible membrane displaces the movable member.

4. The tactile feedback device of claim 3, further comprising a reference surface, wherein the movable member is displaceable with respect to the reference surface.

5. The tactile feedback device of claim 4, wherein the movable member comprises a tactile surface, the tactile surface being displaced beyond the reference surface responsive to the expansion of the expandable substance.

6. The tactile feedback device of claim 5, wherein the reference surface is an outer surface of a housing for the tactile feedback device.

7. The tactile feedback device of claim 6, wherein the movable member is displaced from a first position to a second, distal position responsive to the expansion of the expandable substance, the tactile surface being located beyond the reference surface when the movable member is in the second position.

8. The tactile feedback device of claim 7, wherein the movable member is displaced from the second position to the first position responsive to the expandable substance returning to an unexpanded state.

9. The tactile feedback device of claim 8, wherein the at least one tactile element further comprises a spring biasing the movable member in the first position.

10. The tactile feedback device of claim 9, wherein the expansion of the expandable substance overcomes the bias of the spring allowing the movable member to be displaced to the second position.

11. The tactile feedback device of claim 5, wherein the movable member comprises a button, the tactile surface being located on the button.

12. The tactile feedback device of claim 1, wherein the plurality of tactile elements comprise an array providing tactile feedback of at least Braille characters by selectively displacing the movable member for each of the plurality of tactile elements.

13. The tactile feedback device of claim 12, wherein the array includes at least two columns, each column having at least three tactile elements.

14. The tactile feedback device of claim 13, wherein the array of at least two columns is operable to generate tactile feedback of scrolling characters when a user's appendage is stationary on the array.

15. The tactile feedback device of claim 12, wherein the array includes at least three columns, each column having at least three tactile elements.

16. The tactile feedback device of claim 15, wherein the array of at least three columns is operable to generate tactile feedback of scrolling characters when a user slides an appendage across the array.

17. The tactile feedback device of claim 1, wherein the tactile feedback device is a refreshable Braille display operable to provide tactile feedback of Braille characters by selectively displacing, with respect to a reference, outer surface on a housing of the tactile feedback device, the movable members for each of the plurality of tactile elements.

18. The tactile feedback device of claim 17, wherein the Braille display is connected to a printing device, the Braille display being operable to generate tactile feedback of information related to the printing device.

19. A refreshable Braille display connected to a printing device, wherein the Braille display is configured to generate Braille characters representing information related to the printing device, the Braille display comprising:
a plurality of tactile elements, at least one of the plurality of tactile elements including a movable member and an expandable substance, wherein the movable member is configured to be displaced to provide tactile feedback of a Braille bump in a Braille character responsive to an expansion of the expandable substance.

20. The refreshable Braille display of claim 19, wherein the expandable substance is expanded in response to being heated.

21. A method of providing tactile feedback on a refreshable display, the display comprising a plurality of tactile elements, at least one of the plurality of tactile elements including an expandable substance and a movable member configured to be displaced with respect to a reference surface of the display, the method comprising steps of:
expanding the expandable substance; and
displacing a tactile surface of the movable member beyond the reference surface in response to expanding the expandable substance, the displaced tactile surface providing tactile feedback.

22. The method of claim 21, wherein the step of expanding the expandable substance comprises heating the expandable substance.

23. The method of claim 21, wherein the display is located on a printing device.

24. The method of claim 21, wherein the step of displacing the tactile surface further comprises displacing the tactile surface beyond the reference surface to provide tactile feedback of a Braille bump.

25. A tactile element comprising:
a substance means for expanding; and
a member means for providing tactile feedback, the member means being adjacent to the substance means and being displaced to provide the tactile feedback responsive to an expansion of the substance means.

26. The tactile element of claim 25, further comprising heating means for heating the substance means to cause the substance means to expand.

27. The tactile element of claim 25, further comprising a chamber means for housing the substance means.

28. The tactile element of claim 27, further comprising a cover means for sealing the substance means in the chamber means.

29. The tactile element of claim 28, wherein the cover means is located between the substance means and the member means, wherein the expandable substance expands to displace the cover means such that the cover means displaces the movable member.

30. The tactile feedback device of claim 25, further comprising a reference surface means, wherein the movable member is displaceable with respect to the reference surface means.

31. The tactile feedback device of claim 30, wherein the member means comprises a tactile surface means for providing tactile feedback, the tactile surface means being displaced beyond the reference surface means responsive to the expansion of the substance means.

32. The tactile feedback device of claim 31, wherein the reference surface means is an outer surface of a housing means for housing the tactile feedback device.

33. The tactile feedback device of claim 32, wherein the member means is displaced from a first position to a second, distal position responsive to the expansion of the substance means, the tactile surface means being located beyond the reference surface means when the member means is in the second position.

34. The tactile feedback device of claim 33, wherein the member means is displaced from the second position to the first position responsive to the substance means returning to an unexpanded state.

35. The tactile feedback device of claim 34, further comprising a biasing means for biasing the member means to the first position.

36. The tactile feedback device of claim 35, wherein the expansion of the substance means overcomes the biasing of the biasing means allowing the tactile surface means of the member means to be displaced to the second position.
